(19) United States
(12) Patent Application Publication
(10) Pub. No.: US 2012/0279340 A1
(43) Pub. Date: Nov. 8, 2012

(54) PEDAL ASSEMBLY FOR STEERING SYSTEMS

(76) Inventor: Geoffrey Allan Davis, Mansfield (AU)

(21) Appl. No.: 13/387,952

(22) PCT Filed: Jul. 23, 2010
(86) PCT No.: PCT/AU10/00926

§ 371 Date: Feb. 23, 2012

(30) Foreign Application Priority Data
Jul. 30, 2009 (AU) 2009903545
Feb. 15, 2010 (AU) 2010900596

(51) Int. Cl. B62D 1/02

(52) U.S. Cl. 74/484 R

(57) ABSTRACT

A pedal assembly comprises a pair of pedals connected to a shaft which is rotated by links connected to the pedals such that the links operate in tension when the pedals are depressed. The pedals have spring loaded plungers which return them to a neutral position when there is no pressure on the pedals.

### FIELD OF INVENTION

This invention relates to controls for heavy equipment and in particular to pedal assemblies for steering such equipment.

### BACKGROUND OF THE INVENTION

The control of heavy equipment such as the boom of an open cut mining excavator presents a problem since movement of the boom is achieved by powerful motors which are sensitive to control by the human operator. This control is usually provided by the operation of two foot pedals; depressing the left pedal results in the boom moving to the left and the right results in movement to the right. Any operator failure or any flexing or failure in the pedal assembly can result in the boom swinging out of control and causing massive damage.

WO 2008/134826 discloses a pedal assembly comprising at least one rod attached to an arm, at least one sector gear attached to the arm and a translation gear interconnected with the sector gear wherein the movement of the rod causes movement of the arm and sector gear, resulting in movement of the translation gear which is translated into an electrical signal to move the boom of the dragline excavator. However the rod or rods in this assembly are thrown into compression by operation of the control pedals and there is the possibility that the rods can bend or the linkages fail under compression. Further there is no mechanism to return the pedals to a neutral control position if the operators feet leave the pedals during movement of the boom.

WO 2009/021283 discloses a similar pedal assembly comprising a housing having a pair of pedals pivotally mounted on an upper foot plate which are coupled via links to shafts interconnected in reversing relation. One shaft drives an operating shaft activating one or more signal generating devices, the mechanism having a neutral position where the pedals lie in a common plane. The housing is mounted on a bracket assembly for rotation about an axis which lies substantially in the common plane of the pedals to adjust the rake of the pedals. Although the opposing action mechanism driven by the pedals of this assembly provides for more stable control, the driving shafts are still in compression with the attendant instability and there is no fail safe neutralizing mechanism.

### OBJECT OF THE INVENTION

It is therefore an object of the present invention to provide a pedal assembly which eliminates the disadvantages of the prior art systems to improve operational safety or which at least provides an alternative to prior art systems.

### Statement of the Invention

According to the present invention, a pedal assembly comprises a pair of pedals mounted on a plate and connected to a shaft which is rotated by links connected to said pedals such that the links operate in tension when the pedals are depressed.

Preferably extensions below the heels of the pedals are pivoted to rods which are pivoted to fulcrums fixed to the shaft.

Preferably the pedal assembly has stops to limit the rotation of the fulcrums and hence the depression of the pedals.

Preferably the pedals have a return mechanism which returns them to a neutral position when there is no pressure on the pedals.

Preferably the pedals depress spring loaded plungers which return the pedals to their neutral position when there is no pressure on the pedals.

Preferably the plungers employ helical springs which can be replaced with springs of different tension.

Preferably the shaft interacts with a signal generating device.

Preferably the signal generating device steers a machine.

### BRIEF DESCRIPTION OF THE DRAWINGS

FIG. 1 is a perspective view of a pedal assembly from the right rear side

FIG. 2 is an elevation of the assembly of FIG. 1 from the right side

FIG. 3 is a perspective view of a pedal assembly from the left rear side

FIG. 4 is a plan view of the assembly of FIG. 1 from below with the internal mechanism revealed

### DETAILED DESCRIPTION OF THE INVENTION

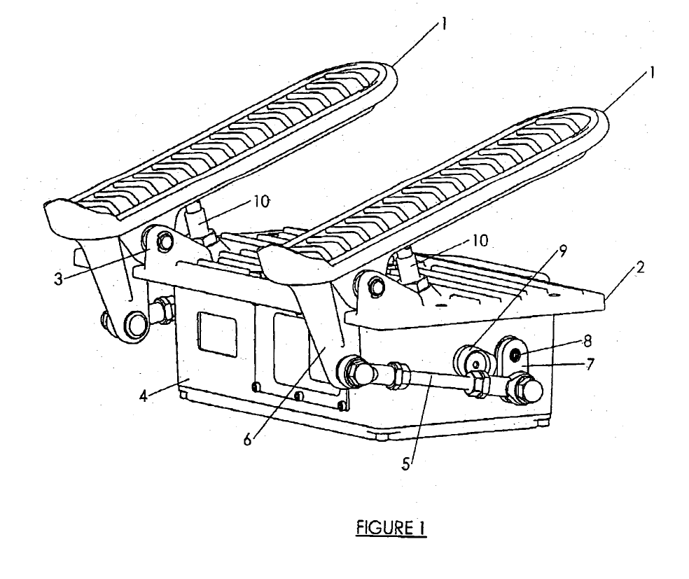

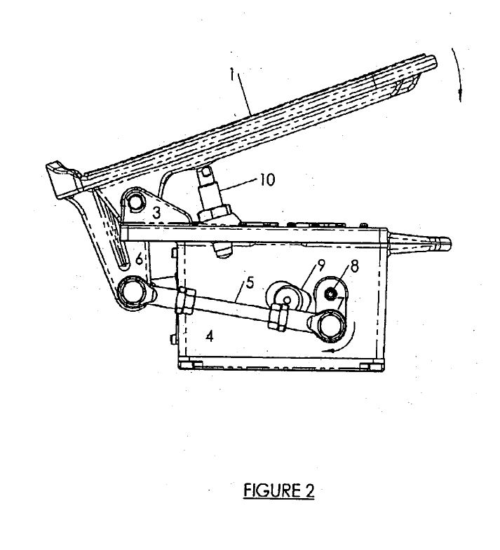

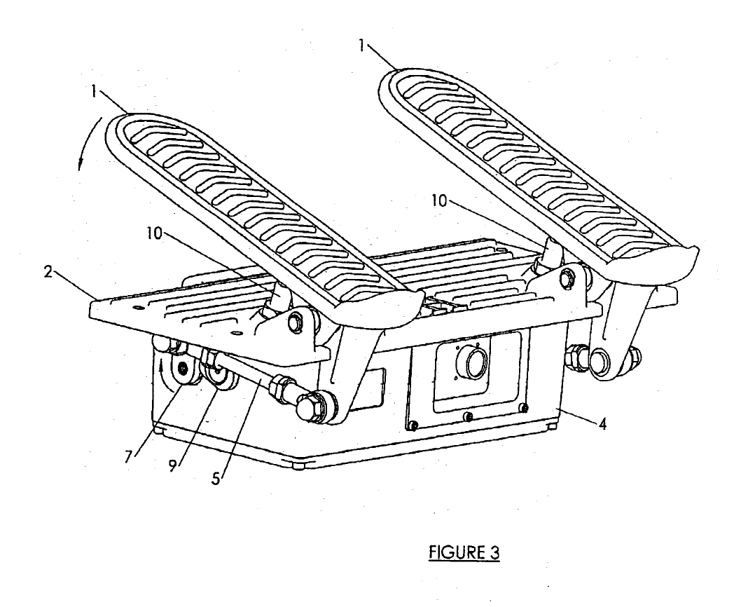

In FIG. 1 pedals 1 are pivoted on base 2 at brackets 3 and base 2 is mounted on top of housing 4. Links 5 extend between extensions 6 of pedals 1 and fulcrums 7 attached to shaft 8, so that when pedals 1 are depressed fulcrums 7 are rotated rearwards. FIG. 2 illustrates this action in relation to right hand pedal 1 where fulcrum 7 rotates below shaft 8 and FIG. 3 illustrates it in relation to left hand pedal 1 where fulcrum 7 rotates above shaft 8.

Accordingly when right hand pedal 1 is depressed shaft 8 rotates in a clockwise direction and when left hand pedal 1 is depressed shaft 8 rotates in an anticlockwise direction. Stops 9 limit the travel of fulcrums 7 and pedals 1 while spring loaded plungers 10 return pedals 1 to their neutral position when there is no pressure on pedals 1. The resistance provided by plungers 10 can be adjusted by changing helical springs (not shown) within plungers 10.

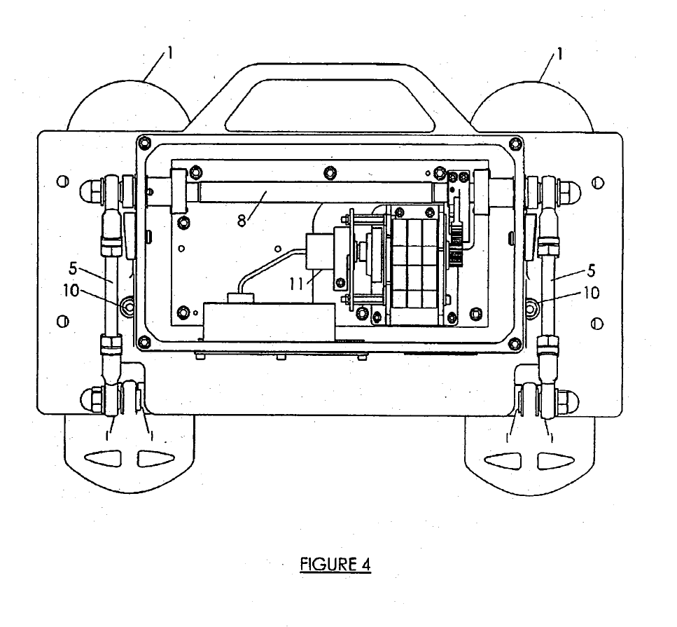

FIG. 4 reveals the internal mechanism of the pedal assembly. Shaft 8 interacts with signal generating device 11 so that clockwise rotation of shaft 8 generates a signal to steer to the right while the opposite rotation generates a signal to steer to the left.

### Advantages

It will be obvious that when pedals 1 are depressed links 5 operate in tension and this affords greater precision of control by the operator than if links 5 were operating in compression as happens in prior art assemblies. This is so because compression links are subject to flexing and failure under pressure compared with links in tension which do not flex.

Further, plungers 10 ensure that If the operator's feet leave the pedals for any reason pedals 1 are returned to a neutral position where no steering signal is generated. Accordingly the assembly of the subject invention enhances the degree of control and safety in the steering operation.

### Variations

It will be realized that the foregoing has been given by way of illustrative example only and that all other modifications and variations as would be apparent to persons skilled in the art are deemed to fall within the broad scope and ambit of the invention as herein set forth. For example various mechanical equivalents could be substituted for the integers of the assembly without departing from the inventive concept. Also different signal generating means and pedal return mechanisms could be used.

Throughout the description and claims to this specification the word “comprise” and variation of that word such as “comprises ” and “comprising” are not intended to exclude other additives components integers or steps.

1. A pedal assembly for steering heavy equipment comprising a pair of pedals mounted on a plate and connected to a shaft which is rotated by links connected to said pedals such that the links operate in tension when the pedals are depressed and wherein rotation of the shaft results in steering of the heavy equipment.

2. The pedal assembly of claim 1 in which extensions below the heels of the pedals are pivoted to rods which are pivoted to fulcrums fixed to the shaft.

3. The pedal assembly of claim 2 which has stops to limit the rotation of the fulcrums and hence the depression of the pedals.

4. The pedal assembly of claim 1 wherein the pedals have a return mechanism which returns them to a neutral position when there is no pressure on the pedals.

5. The pedal assembly of claim 4 in which the pedals depress spring loaded plungers which return the pedals to their neutral position when there is no pressure on the pedals.

6. The pedal assembly of claim 5 in which the plungers employ helical springs which can be replaced with springs of different tension.

7. (canceled)

8. (canceled)

9. A pedal assembly for steering heavy equipment comprising:
a pair of pedals, wherein the pedals comprise heels and extensions below the heels, wherein the heels are pivotally mounted on a plate;
a rotatable shaft, wherein rotation of the shaft results in steering of the heavy equipment;
a pair of fulcrums fixed to the shaft, wherein one fulcrum extends in a generally upward direction and the other fulcrum extends in a generally downward direction;
a link disposed between each fulcrum and each extension, wherein one end of each link is pivotally attached to the extension and the other end of each link is pivotally attached to the fulcrum, such that the shaft is rotated by the links connected to said pedals such that the links operate in tension when the pedals are depressed

10. The pedal assembly of claim 9 which has stops to limit the rotation of the fulcrums and hence the depression of the pedals.

11. The pedal assembly of claim 9 wherein the pedals have a return mechanism which returns them to a neutral position when there is no pressure on the pedals.

12. The pedal assembly of claim 11 in which the pedals depress spring loaded plungers which return the pedals to their neutral position when there is no pressure on the pedals.

13. The pedal assembly of claim 12 in which the plungers employ helical springs which can be replaced with springs of different tension.

14. The pedal assembly of claim 9 wherein the heavy equipment comprises the boom of an excavator.

15. The pedal assembly of claim 1 wherein the heavy equipment comprises the boom of an excavator.
